(19) United States
(12) Patent Application Publication
(10) Pub. No.: US 2012/0172515 A1
(43) Pub. Date: Jul. 5, 2012

(54) Polyphenylene Ether Thermoplastic Resin Composition

(75) Inventors: Jin Kyung CHO, Uiwang-si (KR); Do Hoon CHANG, Uiwang-si (KR); Doo Han HA, Uiwang-si (KR); Ywan Hee LEE, Uiwang-si (KR); Jin Young HUH, Uiwang-si (KR)

(73) Assignee: CHEIL INDUSTRIES INC., Gumi-si (KR)

(21) Appl. No.: 13/300,750

(22) Filed: Nov. 21, 2011

(30) Foreign Application Priority Data
Dec. 30, 2010 (KR) 10-2010-0139635

(51) Int. Cl. C08L 25/06

(52) U.S. Cl. 524/502; 525/190

(57) ABSTRACT

Polyphenylene ether thermoplastic resin compositions are formed by adding a polyamide resin to a composition of a polyphenylene ether resin and a polystyrene resin. The composition can have improved heat deflection temperature while maintaining fluidity of polyphenylene ether.

### CROSS-REFERENCE TO RELATED APPLICATIONS

This application claims priority under 35 USC Section 119 to and the benefit of Korean Patent Application No. 10-2010-0139635 filed Dec. 30, 2010, the entire disclosure of which is incorporated herein by reference.

### FIELD OF THE INVENTION

The present invention relates to polyphenylene ether thermoplastic compositions.

### BACKGROUND OF THE INVENTION

Polyphenylene ether resin compositions can have excellent mechanical and electrical properties at high temperatures and thus can be used in various fields, such as components of electronic and electric products, automobile parts, and the like. However, polyphenylene ether resin compositions typically exhibit poor chemical resistance and inferior workability because of low flow index. Thus, polyphenylene ether resin compositions can be difficult to mold and can have poor workability.

A styrene resin can be added to a polyphenylene ether resin to improve the processibility of polyphenylene ether while also providing heat resistance. For applications such as components of electric and electronic products or automobile parts, it can be important for polyphenylene ether resin compositions to have a heat deflection temperature of 130° C. or more. However, when a resin composition includes a polyphenylene ether resin and a styrene resin to increase fluidity, heat deflection temperature can be decreased. Further, when a resin composition includes a polyphenylene ether resin and a polyamide resin, it can be difficult to maintain impact resistance, dimensional stability, and durability while satisfying heat deflection temperature and fluidity requirements.

### SUMMARY OF THE INVENTION

Exemplary embodiments provide polyphenylene ether thermoplastic resin compositions that can have a heat deflection temperature (HDT) of 130° C. or more and can exhibit an excellent balance of properties such as fluidity, impact resistance, dimensional stability, and durability. The thermoplastic resin compositions can have significantly reduced viscosity at temperatures typically used for extrusion/injection molding and can be useful for applications such as components for electric and electronic products or automobile parts. The thermoplastic resin compositions can further exhibit improved fluidity and heat deflection temperature (HDT) while maintaining or improving impact resistance, dimensional stability, and durability.

In exemplary embodiments, the thermoplastic resin composition can include about 20 to about 80 wt % of a polyphenylene ether resin (A); about 10 to about 70 wt % of a rubber reinforced aromatic vinyl resin (B); and about 2 to about 18 wt % of a polyamide resin (C).

In exemplary embodiments, the thermoplastic resin composition may include about 30 to about 60 wt % of the polyphenylene ether resin (A); about 20 to about 60 wt % of the rubber reinforced aromatic vinyl resin (B); and about 5 to about 15 wt % of the polyamide resin (C).

The rubber reinforced aromatic vinyl resin may include about 70 to about 99.9 wt % of an aromatic vinyl monomer and about 0.1 to about 30 wt % of rubber.

The thermoplastic resin composition may have a heat deflection temperature (HDT) of 130° C. or more, measured according to ASTM D648.

The present invention also provides a molded article made using the thermoplastic resin composition. The molded article may be used for components of electric and electronic products or for automobile parts.

The molded article may be formed of the thermoplastic resin composition. In exemplary embodiments, the molded article includes a polyphenylene ether resin (A), a rubber reinforced aromatic vinyl resin (B), and a polyamide resin (C), has a heat deflection temperature (HDT) of 130° C. or more, measured at a load of 18.56 kgf/cm² according to ASTM D648, and has a durability of 80% or more, measured by Equation 1:

Durability=TSa/Tsi×100,

wherein TSa is tensile strength after aging at 70° C. and 95% relative humidity (RH) for 1000 hours, and TSi is initial tensile strength at 25° C.

### DETAILED DESCRIPTION OF THE INVENTION

The present invention now will be described more fully hereinafter in the following detailed description of the invention, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

A polyphenylene ether thermoplastic resin composition according to the present invention may have a heat deflection temperature (HDT) of about 130° C. or more. For example, the polyphenylene ether thermoplastic resin composition may have an HDT of 135° C. or more, for example about 135 to about 200° C., and as another example about 150 to about 200° C. The HDT may be measured according to ASTM D648, without being limited thereto.

Generally, a polyphenylene ether thermoplastic resin composition used for components of electric and electronic products or automobile parts can have an HDT of about 130° C. or more. For examples, for an air intake manifold that is a peripheral part of a car engine, the polyphenylene ether thermoplastic resin can have an HDT of about 195° C. or more according to reliability testing. As another example, for electric or electronic products, such as junction boxes and fuse boxes, a material having an HDT of about 130° C. or more can be used.

The thermoplastic resin composition may have an HDT of about 130° C. or more, for example about 150 to about 200° C., for applications such as components for electric and electronic products or automobile parts. When a thermoplastic resin composition includes a polyphenylene ether resin and an aromatic vinyl resin to increase fluidity, HDT is decreased. In the present invention, a polyamide resin is added to a composition of a polyphenylene ether resin and an aromatic vinyl resin to improve both HDT and fluidity.

For applications such as components of electric and electronic products, dimensional stability, durability, impact resistance, and moldability of the resins are also important. When the polyamide resin is added to the composition of the polyphenylene ether resin and the aromatic vinyl resin, fluidity and HDT are improved. However, if too much polyamide resin is added, impact resistance, durability, and dimensional stability may be deteriorated. In particular, the polyamide resin is known to have inferior dimensional stability and durability. In this invention, the polyamide resin is added in a particular amount to the composition of the polyphenylene ether resin and the aromatic vinyl resin, thereby improving HDT and fluidity while maintaining impact resistance, durability, and dimensional stability.

The resin composition may have a flexural strength of about 800 to about 1800 kgf/cm² and a flexural modulus of about 20,000 to about 60,000 kgf/cm², which are criteria for determining impact resistance. In this invention, the flexural strength and the flexural modulus are measured on a specimen (thickness: ⅛ inch) at a rate of about 2.8 mm/min according to ASTM D790.

The resin composition may have a durability of about 60% or more, for example about 80% or more. For example, the resin composition may have a durability of about 60 to about 99%, for example about 80 to about 99%. The durability may be defined as a ratio of tensile strength after aging at about 70° C. and about 95% RH for about 1000 hours to initial tensile strength at about 25° C., as represented by Equation 1:

Durability=(TSa/Tsi)×100,

wherein TSa is tensile strength after aging for 1000 hours at 70° C. and 95% RH, and TSi is initial tensile strength at 25° C.

The tensile strength may be measured according to ASTM D638.

The resin composition may have a shrinkage rate of about 0.4% or less, for example about 0.10 to about 0.40% or about 0.3% or less. The shrinkage rate is used to determine dimensional stability and is measured on a rectangular specimen (thickness: 1/8″) according to ASTM D955.

The resin composition may have proper impact resistance, durability, and dimensional stability for applications such as components of electric and electronic products and automobile parts.

The thermoplastic resin composition includes about 20 to about 80 wt % of a polyphenylene ether resin (A); about 10 to about 70 wt % of a rubber reinforced aromatic vinyl resin (B); and about 2 to about 18 wt % of a polyamide resin (C). When the amount of polyamide resin is less than about 2 wt %, flowability of the resin may not sufficiently improve at a conventional injection molding temperature of about 250° C. or more. If the amount of polyamide is reduced and the amount of rubber reinforced aromatic vinyl resin is increased instead, HDT is decreased. If the amount of polyamide resin is greater than about 18 wt %, the polyphenylene ether resin, the rubber reinforced aromatic vinyl resin, and the polyamide resin may not uniformly mix, the composition may not have suitable dimensional stability, hydrolyzing and moisture absorbing properties of the resin can increase deteriorating durability, distortion can occur, and HDT can be insufficient.

In exemplary embodiments, the thermoplastic resin composition may include about 30 to about 60 wt % of a polyphenylene ether resin (A); about 20 to about 60 wt % of a rubber reinforced aromatic vinyl resin (B); and about 5 to about 15 wt % of a polyamide resin (C).

(A) Polyphenylene Ether Resin

Examples of the polyphenylene ether resin may include, without being limited to, poly(2,6-dimethyl-1,4-phenylene)ether, poly(2,6-diethyl-1,4-phenylene)ether, poly(2,6-dipropyl-1,4-phenylene) ether, poly(2-methyl-6-ethyl-1,4-phenylene)ether, poly(2-methyl-6-propyl-1,4-phenylene) ether, poly(2-ethyl-6-propyl-1,4-phenylene)ether, poly(2,6-diphenyl-1,4-phenylene) ether, a copolymer of poly(2,6-dimethyl-1,4-phenylene)ether and poly(2,3,6-trimethyl-1,4-phenylene) ether, a copolymer of poly(2,6-dimethyl-1,4-phenylene)ether and poly(2,3,6-triethyl-1,4-phenylene)ether, and the like, and combinations of two or more thereof.

The thermoplastic resin composition may include the polyphenylene ether resin in an amount of about 20 to about 80 wt %, for example about 30 to about 60 wt %, and as another example about 50 to about 60 wt %, based on the total amount of (A), (B), and (C). In some embodiments, the thermoplastic resin composition may include the polyphenylene ether resin in an amount of about 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, or 80 wt %. Further, according to some embodiments of the present invention, the amount of the polyphenylene ether resin can be in a range from about any of the foregoing amounts to about any other of the foregoing amounts.

When the amount of polyphenylene ether resin is less than about 20 wt %, high HDT may not be obtained. When the amount of polyphenylene ether resin is greater than about 80 wt %, the resin may not have suitable processibility.

The polyphenylene ether resin used for preparation of the resin composition may have a number average molecular weight (Mn) of about 10,000 to about 40,000 g/mol, without being limited thereto. When the polyphenylene ether resin has a number average molecular weight within this rage, the composition may have an appropriate balance of properties such as mechanical strength, heat resistance, and processibility.

(B) Rubber Reinforced Aromatic Vinyl Resin

The rubber reinforced aromatic vinyl resin may be obtained by polymerization of a monomer including an aromatic vinyl monomer with rubber.

The rubber reinforced aromatic vinyl resin may include the aromatic vinyl monomer in an amount of about 70 to about 99.9 wt %, for example about 85 to about 97 wt %. In some embodiments, the rubber reinforced aromatic vinyl resin may include the aromatic vinyl monomer in an amount of about 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 99.1, 99.2, 99.3, 99.4, 99.5, 99.6, 99.7, 99.8, or 99.9 wt %. Further, according to some embodiments of the present invention, the amount of the aromatic vinyl monomer can be in a range from about any of the foregoing amounts to about any other of the foregoing amounts.

When the rubber reinforced aromatic vinyl resin includes the aromatic vinyl monomer in an amount within this range, the resin may be properly mixed in an extrusion/injection process.

Examples of the aromatic vinyl monomer may include, without being limited to, styrene, alkyl and/or halogen substituted styrene, and the like, and combinations thereof. As used herein, the term “alkyl” includes C 1-C10 alkyl. Examples of alkyl and/or halogen substituted styrene monomers include without limitation α-methylstyrene, β-methylstyrene, p-methylstyrene, para-t-butylstyrene, ethylstyrene, and the like, and combinations thereof.

Optionally a polymerizable unsaturated monomer may be used along with the aromatic vinyl monomer. Examples of the polymerizable unsaturated monomer can include without limitation, acrylonitrile, methacrylonitrile, acrylic acid, methacrylic acid, maleic anhydride, N-substituted maleimide, and (meth)acrylic acid alkyl esters (such as (meth)acrylic acid C1-C10 alkyl esters).

The polymerizable unsaturated monomer may be present in an amount of about 40 wt % or less in a monomer mixture including the aromatic vinyl monomer and the polymerizable unsaturated monomer. In some embodiments, the polymerizable unsaturated monomer may not be present (0 wt %), or may be present in an amount of about 0 (the polymerizable unsaturated monomer is present), 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or 40 wt %. Further, according to some embodiments of the present invention, the amount of the polymerizable unsaturated monomer can be in a range from about any of the foregoing amounts to about any other of the foregoing amounts.

Examples of the rubber may include without limitation diene rubbers, such as butadiene rubbers, copolymers of butadiene and styrene, and poly(acrylonitrile-butadiene), saturated rubbers obtained by hydrogenation of the diene rubbers, isoprene rubbers, acrylic rubbers, and ethylene-propylene-diene terpolymers (EPDM). In exemplary embodiments, the rubber can include polybutadiene, a copolymer of butadiene and styrene, isoprene rubber, C1-C10 alkyl acrylate rubbers, or a combination thereof. In exemplary embodiments, the rubber can include crosslinked polybutadiene rubber.

The rubber reinforced aromatic vinyl resin may include the rubber in an amount of about 0.1 to about 30 wt %, for example about 3 to about 12 wt %, based on the total amount of the rubber reinforced aromatic vinyl resin. In some embodiments, the rubber reinforced aromatic vinyl resin may include the rubber in an amount of about 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 wt %. Further, according to some embodiments of the present invention, the amount of the rubber can be in a range from about any of the foregoing amounts to about any other of the foregoing amounts.

When the rubber reinforced aromatic vinyl resin includes the rubber in an amount within this range, heat resistance of the resin can be maintained while exhibiting impact modifying effects.

The rubber may have a Z-average particle size of about 0.1 to about 6 μm, for example about 0.25 to about 3.5 m in order to exhibit appropriate properties.

In exemplary embodiments, the rubber reinforced aromatic vinyl resin may have the rubber particles dispersed in a bimodal form and have a graft ratio of about 0 to about 0.3.

The rubber may have a glass transition temperature of about −100° C. to about −40° C. When the rubber has a glass transition temperature within this range, good impact modifying effects at room temperature can be obtained.

The rubber reinforced aromatic vinyl resin may be prepared by bulk polymerization, suspension polymerization, emulsion polymerization, or combinations thereof. Polymerization may be conducted by thermal polymerization or in the presence of a polymerization initiator. Examples of suitable polymerization initiators may include without limitation peroxide initiators, such as benzoyl peroxide, t-butyl hydroperoxide, acetyl peroxide, and cumene hydroperoxide; and azo initiators, such as azobisisobutyronitrile.

The thermoplastic resin composition may include the rubber reinforced aromatic vinyl resin in an amount of about 10 to about 70 wt %, for example about 20 to about 60 wt %, and as another example about 25 to about 42 wt %, based on the total amount of (A), (B), and (C). In some embodiments, the thermoplastic resin composition may include the rubber reinforced aromatic vinyl resin in an amount of about 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, or 70 wt %. Further, according to some embodiments of the present invention, the amount of the rubber reinforced aromatic vinyl resin can be in a range from about any of the foregoing amounts to about any other of the foregoing amounts.

When the thermoplastic resin composition includes the rubber reinforced aromatic vinyl resin in an amount of less than about 10 wt %, it can be difficult to melt and mold the polyphenylene ether resin. When the thermoplastic resin composition includes the rubber reinforced aromatic vinyl resin in an amount greater than about 70 wt %, HDT can be significantly reduced.

In one embodiment, the amount of the rubber reinforced aromatic vinyl resin may be less than the amount of the polyphenylene ether resin in the overall composition.

(C) Polyamide Resin

Examples of the polyamide resin may include, without being limited to, polycaproamide (nylon 6), polytetramethylene adipamide (nylon 46), polyhexamethylene adipamide (nylon 66), poly(hexamethylene nonanediamide) (nylon 69), poly(hexamethylene sebacamide) (nylon 610), a polycaproamide/polyhexamethylene adipamide copolymer (nylon 6/66), poly(hexamethylene dodecanediamide), polyhexamethylene dodecanamide (nylon 612), nylon 611, polyundecanoamide (nylon 11), polydodecanamide (nylon 12), polyhexamethylene isophthalamide (nylon 61), a polyhexamethylene terephthalamide/polyhexamethylene isophthalamide copolymer (nylon 6T/6I), a polyhexamethylene adipamide/polyhexamethylene terephthalamide copolymer (nylon 66/6T), polybis(4-aminocyclohexyl) methanedodecamide (nylon PACM 12), polybis(3-methyl-4-aminocyclohexyl) methanedodecamide (nylon dimethyl PACM 12), polymetaxylene adipamide (MXD 6), polyundecamethylene terephthalamide (nylon 11T), polyundecamethylene hexahydro terephthalamide (nylon 11T(H)), and the like, copolymers thereof, and combinations of two or more thereof. In exemplary embodiments, polyhexamethylene adipamide (nylon 66) may be used.

The thermoplastic resin composition may include the polyamide resin in an amount of about 2 to about 18 wt %, for example about 5 to about 15 wt %, and as another example about 8 to about 15 wt %, based on the total amount of (A), (B), and (C). In some embodiments, the thermoplastic resin composition may include the polyamide resin in an amount of about 2, 3, 4, 5, 6, 7, 8, 9, 10, 11, 12, 13, 14, 15, 16, 17, or 18 wt %. Further, according to some embodiments of the present invention, the amount of the polyamide resin can be in a range from about any of the foregoing amounts to about any other of the foregoing amounts.

When the thermoplastic resin composition includes the polyamide resin in an amount of less than about 2 wt %, flowability of the resin may not be sufficiently improved at conventional injection molding temperatures of about 250° C. or more. When the amount of polyamide is decreased and the amount of rubber reinforced aromatic vinyl resin is increased instead, heat resistance can be reduced. When the thermoplastic resin composition includes the polyamide resin in an amount greater than about 18 wt %, the polyphenylene ether resin, the rubber reinforced aromatic vinyl resin, and the polyamide resin may not be uniformly mixed, dimensional stability may be inappropriate, hydrolyzing and moisture absorbing properties of the resin can increase deteriorating durability, and distortion may occur.

The thermoplastic resin composition need not include a compatibilizer.

The thermoplastic resin composition may further include at least one or more additives, such as but not limited to an impact modifier and/or fillers.

Examples of the impact modifier include without limitation core-shell-type copolymers, chain-type impact modifiers, and the like, and combinations thereof

Examples of core-shell copolymers include without limitation core-shell copolymers obtained by grafting a rubber polymer with an unsaturated monomer.

Examples of the rubber include without limitation rubbers polymerized from diene monomers, acrylate rubber monomers, silicone rubber monomers, and the like, and combinations thereof

Examples of diene rubbers may include without limitation butadiene rubber, ethylene/propylene rubber, styrene/butadiene rubber, acrylonitrile/butadiene rubber, isoprene rubber, ethylene-propylene-diene terpolymer (EPDM), and the like, and combinations thereof

Examples of acrylate rubber monomers may include without limitation acrylate monomers, such as methyl acrylate, ethyl acrylate, n-propyl acrylate, n-butyl acrylate, 2-ethylhexyl acrylate, hexyl methacrylate, 2-ethylhexyl (meth)acrylate, and the like, and combinations thereof. A curing agent, such as ethylene glycol di(meth)acrylate, propylene glycol di(meth)acrylate, 1,3-butylene glycol di(meth)acrylate, 1,4-butylene glycol di(meth)acrylate, allyl (meth)acrylate, triallyl cyanurate, and the like, and combinations thereof, may be used.

The silicone rubber may be prepared from cyclosiloxanes. Examples of the cyclosiloxanes may include without limitation hexamethyl cyclotrisiloxane, octamethyl cyclotetrasiloxane, decamethyl cyclopentasiloxane, dodecamethyl cyclohexasiloxane, trimethyltriphenyl cyclotrisiloxane, tetramethyltetraphenyl cyclotetrasiloxane, octaphenyl cyclotetrasiloxane, and the like, and combinations thereof. The silicon rubber may be prepared using at least one of these siloxanes. A curing agent, such as trimethoxymethylsilane, triethoxyphenylsilane, tetramethoxysilane, tetraethoxysilane, and the like, and combinations thereof, may be used.

Examples of the unsaturated monomer of the core-shell graft copolymer can include without limitation styrenic monomers, such as styrene, alkyl or halogen substituted styrene; (meth)acrylonitrile; methacrylic acid esters; methacrylic acid alkyl esters; anhydrides; alkyl or phenyl N-substituted maleimide; and the like; and combinations thereof. As used herein, “alkyl” can include C1-C10 alkyl, Also as used herein alkyl or halogen substituted styrene monomers include without limitation a-methylstyrene, β-methylstyrene, p-methylstyrene, para-t-butylstyrene, ethylstyrene, and the like, and combinations thereof.

Examples of chain-type impact modifiers can include without limitation copolymers obtained by grafting a polymer including a thermoplastic polyester or polyolefin as the main chain with an epoxy group or anhydride functional group; and mixtures thereof.

The thermoplastic resin composition may include the impact modifier in an amount of about 5 to about 25 parts by weight, for example about 1 to about 10 parts by weight, based on about 100 parts by weight of (A)+(B)+(C). In some embodiments, the thermoplastic resin composition may include the impact modifier in an amount of about 5, 6, 7, 8, 9, 10, 11, 12, 13, 14, 15, 16, 17, 18, 19, 20, 21, 22, 23, 24, or 25 parts by weight. Further, according to some embodiments of the present invention, the amount of the impact modifier can be in a range from about any of the foregoing amounts to about any other of the foregoing amounts.

When the thermoplastic resin composition includes the impact modifier in an amount within this range, HDT reinforcing effects of polyamide can be improved.

Examples of fillers may include without limitation organic fillers, inorganic fillers, and the like, and combinations thereof. Examples of the fillers may include, without being limited to, carbon black, clay, talc, calcium carbonate, kaolin, diatomite, silica, alumina, graphite, glass beads, fluorine resins, glass fillers, mica, and the like, and combinations thereof The thermoplastic resin composition may include fillers in an amount of about 5 to about 40 parts by weight, for example about 10 to about 30 parts by weight, based on about 100 parts by weight of (A)+(B)+(C). In some embodiments, the thermoplastic resin composition may include filler in an amount of about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or 40 parts by weight. Further, according to some embodiments of the present invention, the amount of filler can be in a range from about any of the foregoing amounts to about any other of the foregoing amounts.

The thermoplastic resin composition may further include one or more other additives. Examples of other additives may include without limitation flame retardants, lubricants, release agents, antifriction agents, coloring agent such as pigments, dyes, and combinations thereof, a small amount of various polymers, and the like, and combinations thereof. Examples thereof are known to those skilled in the art.

The thermoplastic resin composition may be prepared by any known method of preparing a resin composition. For example, the constituent elements and other additives can be mixed, and the mixture can be melt-extruded and formed into pellets by an extruding machine.

According to the present invention, a molded article may be formed of the thermoplastic resin composition. The molded article may include, for example, components of electric and electronic products or automobile parts, without being limited thereto.

Hereinafter, the constitution and functions of the present invention will be explained in more detail with reference to the following examples. These examples are provided for illustrative purposes only and are not to be in any way construed as limiting the present invention.

A description of details apparent to those skilled in the art will be omitted.

### Examples

Details of components used in Examples and Comparative Examples are described as follows.

(A) Polyphenylene ether resin: PX 100F (Mitsubishi Engineering Plastics)

(B) Rubber reinforced polystyrene resin: HR1360 (Cheil Industries Inc.)

(C) Polyamide resin: Polyamide 66 (Leona-1300, Asahi Kasei Chemicals Corp.)

(D) Filler: Spherical glass particles (diameter: 13 μm, T249, Nippon electric glass.)

(E) Impact modifier: Keraton D1107 (Keraton Polymers LLC.)

### Examples 1 to 7

### Preparation of Resin Composition

The polyphenylene ether resin, the rubber reinforced polystyrene resin, the polyamide resin, the filler, and the impact modifier are mixed according to the amounts listed in Table 1 to prepare a resin composition.

### Comparative Examples 1 to 6

### Preparation of Resin Composition

Resin compositions are prepared in the same manner as in Examples 1 to 7 except that the components are used in the amounts listed in Table 2.

TABLE 1

| | Examples | | | | | | |
|---|---|---|---|---|---|---|---|
| | 1 | 2 | 3 | 4 | 5 | 6 | 7 |
| (A) Polyphenylene ether resin | 60 | 60 | 60 | 50 | 60 | 60 | 60 |
| (B) Rubber reinforced | 35 | 30 | 25 | 42 | 32 | 32 | 32 |
| polystyrene resin | | | | | | | |
| (C) Polyamide resin | 5 | 10 | 15 | 8 | 8 | 8 | 8 |
| (D) Filler | — | — | — | — | 20 | — | 20 |
| (E) Impact modifier | — | — | — | — | — | 10 | 10 |

(Unit: parts by weight)

TABLE 2

| | Comparative Example | | | | | |
|---|---|---|---|---|---|---|
| | 1 | 2 | 3 | 4 | 5 | 6 |
| (A) Polyphenylene ether resin | 40 | 50 | 50 | 50 | 60 | 60 |
| (B) Rubber reinforced | 60 | 50 | 49 | 30 | 20 | 20 |
| polystyrene resin | | | | | | |
| (C) Polyamide resin | — | — | 1 | 20 | 20 | 20 |
| (D) Filler | — | — | — | — | 20 | — |
| (E) Impact modifier | — | — | — | — | — | 10 |

(Unit: parts by weight)

### Experimental Example

### Evaluation of Physical Properties of Resin Compositions

Each of the resin compositions prepared in Examples and Comparative Examples is supplied to a biaxial extruding machine (diameter: 45φ/D=36) at a supply rate of 50 kg/hr and a stirring rate of 250 rpm, and extruded at 240° C. The extruded product is formed into pellets, followed by preparation of a specimen at an injection temperature of 250° C. to evaluate physical properties. Melt index, heat deflection temperature (HDT), flexural strength (HS), flexural modulus (HM), distortion, and durability of the specimens are evaluated, and results are illustrated in Tables 3 and 4.

<Methods of Measuring Physical Properties>

1. Melt Index (unit: g/10 min) The melt index of each specimen is measured at 285° C. and a load of 5 kg according to ASTM D1238.

2. Heat Deflection Temperature

The heat deflection temperature of each specimen is measured at a load of 18.56 kgf/cm² according to ASTM D648.

3. Flexural Strength and Flexural Modulus (unit: kgf/cm²)

The flexural strength and the flexural modulus of each ⅛ inch thick specimen is measured at a rate of 2.8 mm/min according to ASTM D790.

4. Shrinkage Rate

The shrinkage rate of each ⅛″ inch thick rectangular specimen is measured according to ASTM D955. In the following tables, “flow” means a flow direction parallel with a direction of resin entering a gate of the specimen, and “xflow” means a flow direction perpendicular thereto.

5. Distortion

Each 1/16″ inch thick specimen is observed with the naked eye. Larger numbers indicate more serious distortion.

6. Durability (%)

Each specimen is aged at 70° C. and 95% RH for 1000 hours, followed by measurement of tensile strength as compared with initial tensile strength at 25° C. Then, durability is calculated by Equation 1. Tensile strength is measured according to ASTM D638.

Durability=(TSa/Tsi)×100 [Equation 1]

wherein TSa is tensile strength after aging at 70° C. and 95% RH for 1000 hours, and TSi is initial tensile strength at 25° C.

TABLE 3

| | | Example | | | | | | |
|---|---|---|---|---|---|---|---|---|
| | | 1 | 2 | 3 | 4 | 5 | 6 | 7 |
| Melt index | | 50 | 55 | 62 | 76 | 30 | 41 | 24 |
| (g/10 min) | | | | | | | | |
| HDT (° C.) | | 140 | 142 | 144 | 135 | 165 | 135 | 160 |
| HS (kgf/cm²) | | 1300 | 1300 | 1250 | 1000 | 1500 | 1400 | 1550 |
| HM (kgf/cm²) | | 25000 | 26000 | 26500 | 23000 | 50000 | 22000 | 42000 |
| Shrinkage | flow | 0.20 | 0.21 | 0.24 | 0.22 | 0.22 | 0.21 | 0.20 |
| rate (%) | xflow | 0.29 | 0.30 | 0.32 | 0.30 | 0.37 | 0.28 | 0.34 |

| | | | | | | | |
|---|---|---|---|---|---|---|---|
| Distortion | 1 | 1 | 2 | 1 | 2 | 1 | 2 |
| Durability (%) | 90 | 85 | 81 | 86 | 90 | 91 | 91 |

TABLE 4

| | | Comparative Example | | | | | |
|---|---|---|---|---|---|---|---|
| | | 1 | 2 | 3 | 4 | 5 | 6 |
| Melt index | | 70 | 60 | 60 | 75 | 42 | 66 |
| (g/10 min) | | | | | | | |
| HDT (° C.) | | 110 | 120 | 120 | 135 | 168 | 129 |
| HS (kgf/cm²) | | 900 | 1000 | 970 | 800 | 1300 | 1300 |
| HM (kgf/cm²) | | 20,000 | 24000 | 23000 | 20000 | 47000 | 21000 |
| Shrinkage | flow | 0.22 | 0.25 | 0.24 | 0.38 | 0.40 | 0.36 |
| rate (%) | xflow | 0.24 | 0.24 | 0.25 | 0.51 | 0.61 | 0.50 |

| | | | | | | |
|---|---|---|---|---|---|---|
| Distortion | 1 | 1 | 1 | 4 | 5 | 4 |
| Durability (%) | 89 | 91 | 88 | 58 | 60 | 60 |

As shown in Tables 3 and 4, the thermoplastic resin compositions according to Examples 1 to 7 have an improved HDT of 130° C. or higher and maintain a balance of fluidity, impact resistance, dimensional stability, and durability. Further, the compositions including fillers exhibit increased HDT improving effects of the polyamide resin.

In contrast, Comparative Examples 1 to 3 (including less than 3 wt % of the polyamide resin) have insignificant HDT improving effects. Further, Comparative Examples 4 to 6 (including more than 18 wt % of the polyamide resin) exhibit improved HDT but suffer high shrinkage and serious distortion, and thus have inappropriate dimensional stability and decreased durability.

Many modifications and other embodiments of the invention will come to mind to one skilled in the art to which this invention pertains having the benefit of the teachings presented in the foregoing description. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

What is claimed is:

1. A thermoplastic resin composition comprising:
about 20 to about 80 wt % of a polyphenylene ether resin (A);
about 10 to about 70 wt % of a rubber reinforced aromatic vinyl resin (B); and
about 2 to about 18 wt % of a polyamide resin (C).

2. The thermoplastic resin composition of claim 1, wherein the thermoplastic resin composition comprises about 30 to about 60 wt % of the polyphenylene ether resin (A);
about 20 to about 60 wt % of the rubber reinforced aromatic vinyl resin (B); and about 5 to about 15 wt % of the polyamide resin (C).

3. The thermoplastic resin composition of claim 1, wherein the rubber reinforced aromatic vinyl resin comprises about 70 to about 99.9 wt % of an aromatic vinyl monomer and about 0.1 to about 30 wt % of rubber.

4. The thermoplastic resin composition of claim 3, wherein the rubber comprises diene rubber, saturated rubber obtained by hydrogenation of diene rubber, isoprene rubber, acrylic rubber, ethylene-propylene-diene terpolymer (EPDM), or a combination thereof

5. The thermoplastic resin composition of claim 4, wherein the diene rubber comprises butadiene rubber, a copolymer of butadiene and styrene, poly(acrylonitrile-butadiene), or a combination thereof

6. The thermoplastic resin composition of claim 1, wherein the thermoplastic resin composition has a heat deflection temperature (HDT) of 130° C. or more, measured according to ASTM D648.

7. The thermoplastic resin composition of claim 1, wherein the thermoplastic resin composition has a flexural strength of about 800 to about 1,800 kgf/cm² and has a flexural modulus of about 20,000 to 60,000 kgf/cm², measured according to ASTM D790.

8. The thermoplastic resin composition of claim 1, wherein the thermoplastic resin composition has a shrinkage rate of about 0.10 to about 0.40%, measured according to ASTM D955.

9. The thermoplastic resin composition of claim 1, wherein the thermoplastic resin composition further comprises about 5 to about 25 parts by weight of an impact modifier based on about 100 parts by weight of (A)+(B)+(C).

10. The thermoplastic resin composition of claim 1, wherein the thermoplastic resin composition further comprises about 5 to about 40 parts by weight of filler based on about 100 parts by weight of (A)+(B)+(C).

11. A molded article formed of the thermoplastic resin composition of claim 1.

12. The molded article of claim 11, wherein the molded article comprises a component of an electric or electronic product.

13. The molded article of claim 11, wherein the molded article comprises an automobile part.

14. A molded article comprising a polyphenylene ether resin (A), a rubber reinforced aromatic vinyl resin (B), and a polyamide resin (C), wherein the molded article has a heat deflection temperature (HDT) of 130° C. or more, measured at a load of 18.56 kgf/cm² according to ASTM D648, and has a durability of 80% or more, measured by Equation 1:
Durability=(TSa/Tsi)×100,
wherein TSa is tensile strength after aging at 70° C. and 95% RH for 1000 hours, and TSi is initial tensile strength at 25° C.
